(19) United States
(12) Patent Application Publication
(10) Pub. No.: US 2026/0104591 A1
(43) Pub. Date: Apr. 16, 2026

(54) IMAGE PROJECTION SYSTEM

(71) Applicant: Infineon Technologies AG, Neubiberg (DE)

(72) Inventors: Boris KIRILLOV, Gratwein-Straßengel (AT); André BROCKMEIER, Villach (AT); Maksym Yuriiovych SLADKOV, Graz (AT)

(21) Appl. No.: 19/347,078

(22) Filed: Oct. 1, 2025

(30) Foreign Application Priority Data
Oct. 15, 2024 (DE) 102024209998.8

(51) Int. Cl. G02B 27/01; G02B 1/02; G02B 26/08; G02B 26/10

(52) U.S. Cl. CPC G02B 27/0172; G02B 1/02; G02B 27/0176; G02B 26/0833; G02B 26/101; G02B 2027/015; G02B 2027/0178

(57) ABSTRACT

An image projection system includes a layer stack defining an internal cavity, and a microelectromechanical system (MEMS) mirror arranged in the internal cavity. The layer stack includes a first glass layer, a first semiconductor crystal layer, a second semiconductor crystal layer, and a second glass layer, the internal surfaces of which define the internal cavity. The second semiconductor crystal layer includes a first internal slanted surface and a second internal slanted surface that define a portion of the internal cavity. The first internal slanted surface is configured to receive light beams from a light source and direct the light beams toward the second internal slanted surface. The second internal slanted surface is configured to receive the light beams from the first internal slanted surface and direct the light beams toward the MEMS mirror. The MEMS mirror is configured to steer the light beams to render an image.

### CROSS-REFERENCE TO RELATED APPLICATION

This application claims priority to Germany Patent Application No. 102024209998.8 filed on Oct. 15, 2024, the content of which is incorporated by reference herein in its entirety.

### BACKGROUND

Augmented reality (AR) is a technology that provides an interactive user-experience that combines real-world and computer-generated content. AR delivers visual elements, sound, haptics, and/or other sensory information to a user in order to alter the user's ongoing perception of a real-world environment in real-time. In other words, AR adds digital elements to a live experience of the real-world environment. The sensory information overlaid with the real-world environment can be constructive, in order to add the sensory information to the real-world environment, or destructive, in order to mask part of the real-world environment. The sensory information may be delivered to the user through a device, such as a mobile device. For example, a perceived part of the real-world environment may be augmented with digital information that is superimposed thereon. In some cases, visual content may be superimposed onto the user's line-of-sight (e.g., a user's real-world view). Thus, digital content may be overlaid onto the perceived part of the environment to visually provide additional information to the user. The digital content may be displayed on a transparent substrate or display, such as smart eyeglasses, smart contact lenses, head-up displays (HUDs), and head-mounted displays (HMDs), or projected directly onto a user's retina, as is the case for virtual retinal displays.

Virtual reality (VR) is a technology that creates a totally artificial, computer-generated environment in which a user is immersed. Thus, the user's perception of reality is completely based on virtual information. The user may experience a virtually rendered environment with sight and sound through a VR headset or a multi-projected environment. For example, computer-generated stereo visuals may place the user into the virtually rendered environment that provides the user with an immersive feel that is intended to simulate sensations that the user would otherwise experience in the real-world.

Mixed reality (MR) is a technology that combines elements of both AR and VR such that real-world and digital objects interact in real time. MR may allow real and virtual elements to interact with one another and the user to interact with the virtual elements like they would in the real-world. Here, a real-world environment is blended with a virtual environment. Since MR maintains a connection to the real-world, MR is not considered a fully-immersive experience like VR. The user may experience an MR environment using an MR headset or MR glasses.

These technologies, as well as others that interact with a user's senses, may be referred to as extended reality (XR) technologies.

### SUMMARY

In some implementations, an image projection system includes a light source configured to generate light beams corresponding to an image; a layer stack defining an internal cavity, the layer stack including: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer, the second semiconductor crystal layer, and the second glass layer define the internal cavity; and a microelectromechanical system (MEMS) mirror arranged in the internal cavity and suspended from the first semiconductor crystal layer, wherein the second semiconductor crystal layer includes a first internal slanted surface and a second internal slanted surface optically coupled to the first internal slanted surface, wherein the first internal slanted surface and the second internal slanted surface define a portion of the internal cavity, wherein the first internal slanted surface is configured to receive the light beams from the light source and direct the light beams toward the second internal slanted surface, wherein the second internal slanted surface is configured to receive the light beams from the first internal slanted surface and direct the light beams toward the MEMS mirror, and wherein the MEMS mirror is configured to steer the light beams to render the image.

In some implementations, an image projection system includes a light source configured to generate light beams corresponding to an image; a layer stack defining an internal cavity, the layer stack including: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer, the second semiconductor crystal layer, and the second glass layer define the internal cavity; a MEMS mirror arranged in the internal cavity and suspended from the first semiconductor crystal layer; a first grating arranged on the first glass layer, within the internal cavity at an input side of the internal cavity; and a deflecting element arranged within the internal cavity at an output side of the internal cavity, wherein the deflecting element is optically coupled to the first grating, wherein the first grating is configured to receive the light beams from the light source and direct the light beams toward the deflecting element, wherein the deflecting element is configured to receive the light beams from the first grating and direct the light beams toward the MEMS mirror, and wherein the MEMS mirror is configured to steer the light beams to render the image.

In some implementations, an image projection system includes a light source configured to generate light beams corresponding to an image; a layer stack defining an internal cavity, the layer stack including: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer arranged, the second semiconductor crystal layer, and the second glass layer define the internal cavity; a MEMS mirror arranged in the internal cavity and suspended from the first semiconductor crystal layer; couple-in optics configured to couple the light beams into the internal cavity through the first glass layer; and a deflecting element arranged within the internal cavity at an output side of the internal cavity, wherein the deflecting element is optically coupled to the couple-in optics, wherein the couple-in optics is configured to receive the light beams from the light source and direct the light beams toward the deflecting element, wherein the deflecting element is configured to receive the light beams from the couple-in optics and direct the light beams toward the MEMS mirror, and wherein the MEMS mirror is configured to steer the light beams to render the image.

In some implementations, an image projection system includes a light source configured to generate light beams corresponding to an image; a layer stack defining an internal cavity, the layer stack including: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer arranged, the second semiconductor crystal layer, and the second glass layer define the internal cavity; a MEMS mirror arranged in the internal cavity and suspended from the first semiconductor crystal layer; and couple-in optics configured to couple the light beams into the internal cavity through the second glass layer, wherein the couple-in optics is configured to receive the light beams from the light source and direct the light beams into the internal cavity, and wherein the MEMS mirror is configured to steer the light beams to render the image.

### BRIEF DESCRIPTION OF THE DRAWINGS

Implementations are described herein making reference to the appended drawings.

FIG. 1A is a cross-section of an image projection system according to one or more implementations.

FIG. 1B is a cross-section of a layer stack of the image projection system described in connection with FIG. 1A.

FIG. 2A is a cross-section of an image projection system according to one or more implementations.

FIG. 2B is a cross-section of a layer stack of the image projection system described in connection with FIG. 2A.

FIG. 3A is a cross-section of an image projection system according to one or more implementations.

FIG. 3B is a cross-section of an image projection system according to one or more implementations.

FIG. 3C is a cross-section of an image projection system according to one or more implementations.

FIG. 3D is a cross-section of an image projection system according to one or more implementations.

FIG. 3E is a cross-section of an image projection system according to one or more implementations.

FIG. 4A is a cross-section of an image projection system according to one or more implementations.

FIG. 4B is a cross-section of an image projection system according to one or more implementations.

FIG. 5 is a diagram of extended reality eyeglasses in accordance with one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view, rather than in detail, in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually interchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

Wearable headgear, such as eyeglasses and head-mounted displays (HMDs), may be used in extended reality (XR) technologies. For example, augmented reality (AR) is a technology that augments physical environments on a mobile device screen by overlaying the physical environments with digital content. AR adds digital elements to a live view. For example, a captured piece of an environment is augmented with digital information that is superimposed thereon. Thus, digital content is overlaid onto the captured piece of the environment to visually provide additional information to a user. The digital content may be projected directly onto a user's retina, as is the case for virtual retinal displays. Virtual reality (VR) is a technology that entirely replaces the real-world environment of a user with a computer-generated virtual environment. Thus, a user is presented with a completely digital environment in which computer-generated stereo visuals surround the user. In a VR simulated environment, a VR headset that provides 360-degree vision may be used. A mixed reality (MR) experience combines elements of both AR and VR such that real-world and digital objects interact. Here, a real-world environment is blended with a virtual one. These technologies, as well as others that enhance a user's senses, may be referred to as XR technologies.

Binocular vision can be implemented in image projection systems and can be used in some XR technologies by projecting images into both eyes of the user. In some XR technologies, stereoscopic imaging may be used to create an illusion of depth by projecting two slightly offset images separately to each eye of the user. For example, the two slightly offset images (e.g., two stereo images) may be of a same scene or a same object but with an illusion of being projected from slightly different angles or perspectives. In other words, the two stereo images may be combined to create a stereoscopic image that has the illusion of depth. Generating the two stereo images should be performed in a synchronized manner in order for the user to properly perceive a coherent image having the illusion of depth.

When an image projection system is implemented in wearable headgear, such as eyeglasses, reducing a size or footprint of the image projection system may be the highest priority to reduce bulk and increase comfort to a user. In addition, using curved glass in the image projection system may add to the complexity and cost of the image projection system. For example, curved glass typically adds bulk to the image projection system. In addition, curved glass is more difficult to manufacture, and thus, more expensive, than using flat glass. A more compact image projection system that uses flat glass instead of curved glass may be desired.

Some implementations disclosed herein are directed to a compact image projection system that uses flat glass structures. Thus, the compact image projection system may be devoid of curved glass structures. The compact image projection system may have a vertically stacked arrangement in order to reduce a lateral footprint of the compact image projection system. For example, the compact image projection system may be made smaller than 0.3 cm³, in particular smaller than 0.2 cm³, as opposed to >1.0 cm³ of conventional image projection systems. The compact image projection system may be a light engine or picture generation unit that is optically coupled to an eyeglass lens of eyeglasses. The compact image projection system may be duplicated for each eyeglass lens of the eyeglasses.

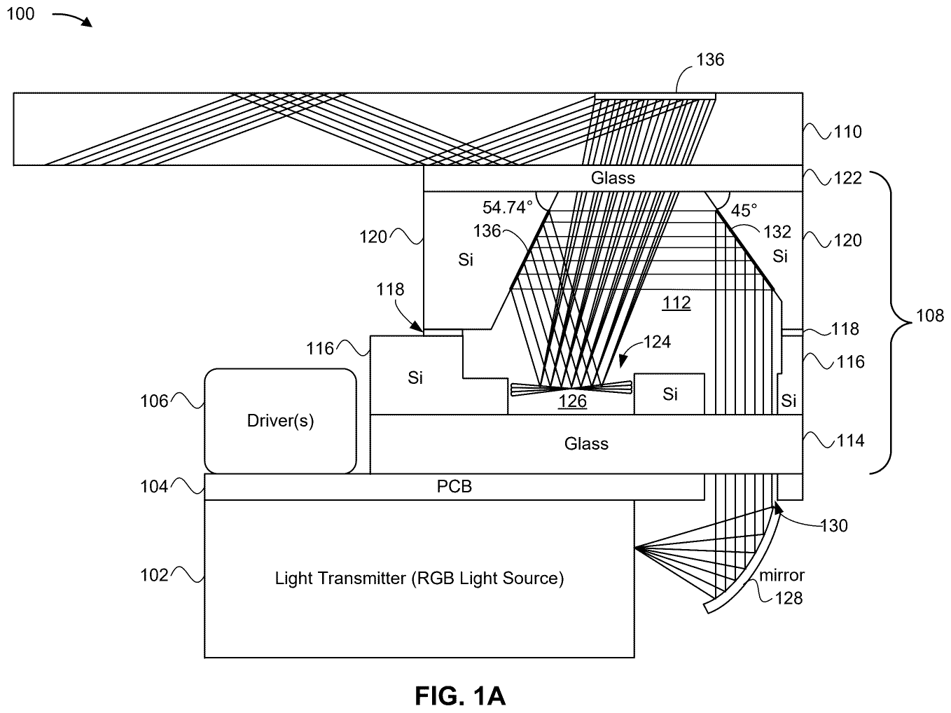

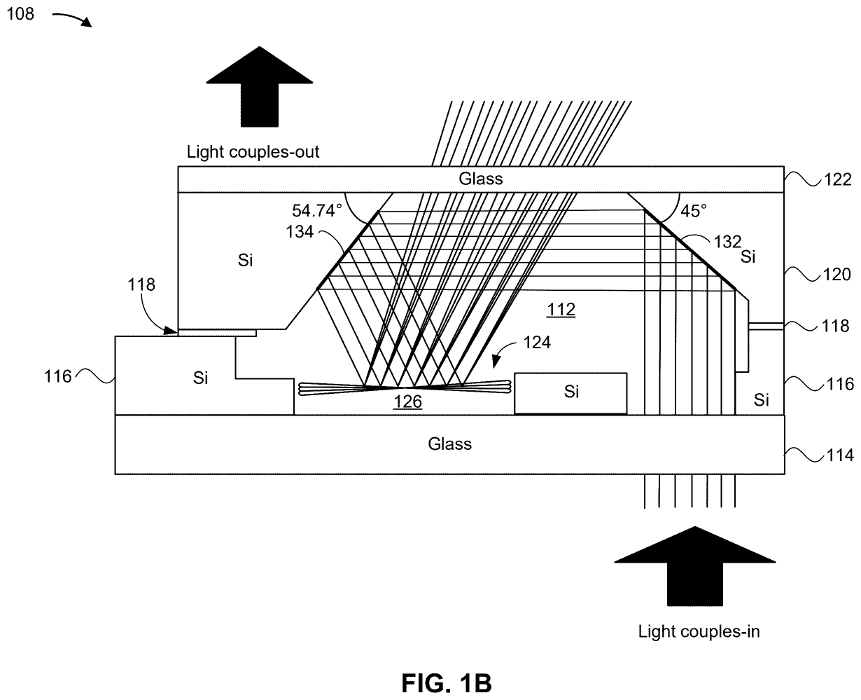

FIG. 1A is a cross-section of an image projection system 100 according to one or more implementations. The image projection system 100 may be implemented as a picture generation unit or light engine for eyeglasses. In other words, the image projection system 100 may be a wearable image projection system comprising an eyeglass lens. The image projection system 100 may include a light transmitter 102, a printed circuit board (PCB) 104 arranged on the light transmitter 102, one or more drivers 106 arranged on the PCB 104, a layer stack 108 arranged on the PCB 104, and an output waveguide 110 arranged on the layer stack 108.

The light transmitter 102 may be a light source, such as a red-green-blue (RGB) light source comprising discrete red, green, and blue light sources. The light transmitter 102 may generate light beams corresponding to an image, such as an RGB image. The light transmitter 102 may be configured for coupling the light beams into the layer stack 108.

The output waveguide 110 may be an eyeglass lens of eyeglasses, or may be coupled to the eyeglass lens for delivering the light beams to an eye of a user. Thus, the output waveguide 110 may be configured to guide the light beams, coupled out of the layer stack 108, toward an eye of the user.

The layer stack 108 is arranged between the light transmitter 102 and the output waveguide 110. The layer stack 108 defines an internal cavity 112 in which the light beams are manipulated. The layer stack 108 includes a first glass layer 114 (e.g., a bottom glass layer), a first semiconductor crystal layer 116 arranged on the first glass layer 114, a bonding interface 118, a second semiconductor crystal layer 120 arranged on the first semiconductor crystal layer 16, and a second glass layer 122 (e.g., a top glass layer) arranged on the second semiconductor crystal layer 120. The first glass layer 114 and the second glass layer 122 are flat glass structures. The output waveguide 110 is arranged on the second glass layer 122. The light transmitter 102 is coupled to the first glass layer 114 (e.g., indirectly via the PCB 104), opposite the first semiconductor crystal layer 116. Internal surfaces of the first glass layer 114, the first semiconductor crystal layer 116, the second semiconductor crystal layer 120, and the second glass layer 122 define the internal cavity 112.

The bonding interface 118 may bond the first semiconductor crystal layer 116 and the second semiconductor crystal layer 120. For example, the bond may be a glass frit bond, a fusion bond, or an anodic bond. Thus, in some implementations, the bonding interface 118 may be glass (e.g., for glass frit bonding or anodic bonding). For anodic bonding, the bonding interface 118 may be a glass layer (e.g., a third glass layer) to which the first semiconductor crystal layer 116 and the second semiconductor crystal layer 120 are both bonded.

The image projection system 100 may further include a microelectromechanical system (MEMS) mirror 124 arranged in the internal cavity 112 and suspended from the first semiconductor crystal layer 116. The MEMS mirror 124 may be suspended over a back cavity 126 that is formed in the first semiconductor crystal layer 116. The MEMS mirror 124 may be implemented as a scanning structure that is configured to steer or otherwise deflect light beams according to a scanning pattern. The MEMS mirror 124 is a mechanical moving mirror (e.g., a MEMS micro-mirror) configured to rotate or oscillate via rotation about two scanning axes that are typically orthogonal to each other. For example, the two scanning axes may include a first scanning axis that enables the MEMS mirror 124 to steer light in a first scanning direction (e.g., an x-direction) and a second scanning axis that enables the MEMS mirror 124 to steer light in a second scanning direction (e.g., a y-direction). As a result, the MEMS mirror 124 can direct light beams in two dimensions.

The one or more drivers 106 may be electrically connected to the light transmitter 102 and the MEMS mirror 124, respectively, via the PCB 104. For example, one driver of the one or more drivers 106 may drive the light transmitter 102 to generate light beams (e.g., light pulses), and another driver of the one or more drivers 106 may drive the MEMS mirror 124 about the two scanning axes. In some implementations, a separate MEMS driver may be used for each scanning axis.

The image projection system 100 may further include couple-in optics 128 configured to couple the light beams into the internal cavity 112 through the first glass layer 114. For example, the couple-in optics 128 may be a concave mirror, such as a collimation mirror. The couple-in optics 128 may receive the light beams from the light transmitter 102 and couple the light beams into the internal cavity 112 through an opening 130 formed in the PCB 104. Thus, the light beams may enter the internal cavity 112 and may pass through the opening 130 and through the first glass layer 114.

The second semiconductor crystal layer 120 includes a first internal slanted surface 132 and a second internal slanted surface 134 optically coupled to the first internal slanted surface 132. The first internal slanted surface 132 and the second internal slanted surface 134 may be reflective surfaces. For example, the first internal slanted surface 132 and the second internal slanted surface 134 may be polished surfaces or may have a thin reflective layer, such as aluminum, deposited thereon. The first internal slanted surface 132 and the second internal slanted surface 134 may define a portion of the internal cavity 112. The first internal slanted surface 132 is configured to receive the light beams from the light transmitter 102 (e.g., from the couple-in optics 128) and direct the light beams toward the second internal slanted surface 134. The second internal slanted surface 134 is configured to receive the light beams from the first internal slanted surface 132 and direct the light beams toward the MEMS mirror 124. The MEMS mirror 124 is configured to steer the light beams to render the image. The MEMS mirror 124 may direct the light beams toward the output waveguide 110. Thus, the layer stack 108 may be configured such that the light beams are coupled into the internal cavity 112 through the first glass layer 114, and are coupled out of the internal cavity 112 through the second glass layer 122. The output waveguide 110 may receive the light beams from the MEMS mirror 124 and guide the light beams toward an eye of the user.

The first internal slanted surface 132 and the second internal slanted surface 134, along with the stack configuration of the image projection system 100, enable the image projection system 100 to be more compact in a lateral dimension than traditional designs. The first internal slanted surface 132 and the second internal slanted surface 134 are crystallographic surfaces of the second semiconductor crystal layer 120. “Crystallographic surface” may refer to a flat, external boundary of a crystal that corresponds to a particular arrangement of atoms in a crystalline material. In crystallography, these surfaces are usually described in terms of their Miller indices, which are integers that denote the orientation of a crystal plane relative to the axes of the crystal lattice.

In some implementations, the first semiconductor crystal layer 116 and the second semiconductor crystal layer 120 are silicon crystal layers. The crystallographic surfaces of silicon (Si), like other crystals, are defined by the orientations of planes in the crystal lattice. Silicon has a diamond cubic structure, meaning that its atoms are arranged in a very specific repeating pattern. The angles at which surfaces can be formed depend on how the surface aligns with the planes of atoms in the crystal. A (100) lattice plane, or surface, is parallel to one of the cubic faces of the silicon lattice. This (100) surface is one of the most commonly used in semiconductor manufacturing because it allows for a relatively simple atomic arrangement. An angle between the (100) surface and a (110) surface of a silicon crystal is 45°. An angle between the (100) surface and a (111) surface of a silicon crystal is 54.74°. The first internal slanted surface 132 and the second internal slanted surface 134 may be etched along boundaries that correspond to a crystallographic surface. Thus, the first internal slanted surface 132 may extend at a first angle of 45° or 54.74°, and the second internal slanted surface 134 may extend at a second angle of 45° or 54.74°. The MEMS mirror 124 may be arranged at a location within the internal cavity 112 according to the combination of the first angle and the second angle such that the MEMS mirror 124 is aligned with the optical path to receive the light beams from the second internal slanted surface 134.

The image projection system 100 may further include a waveguide grating 136 coupled to the output waveguide 110. The waveguide grating 136 may be arranged at an upper surface of the output waveguide 110 on a side opposite the second glass layer 122. The waveguide grating 136 may receive the light beams from the MEMS mirror 124 and couple the light beams into the output waveguide 110. Thus, the waveguide grating 136 may direct the light beams along a waveguide path of the output waveguide 110.

As indicated above, FIG. 1A is provided as an example. Other examples may differ from what is described with regard to FIG. 1A.

FIG. 1B is a cross-section of the layer stack 108 of the image projection system 100 described in connection with FIG. 1A. The layer stack 108 is configured such that the light beams are coupled into the internal cavity 112 through the first glass layer 114, and are coupled out of the internal cavity 112 through the second glass layer 122.

As indicated above, FIG. 1B is provided as an example. Other examples may differ from what is described with regard to FIG. 1B.

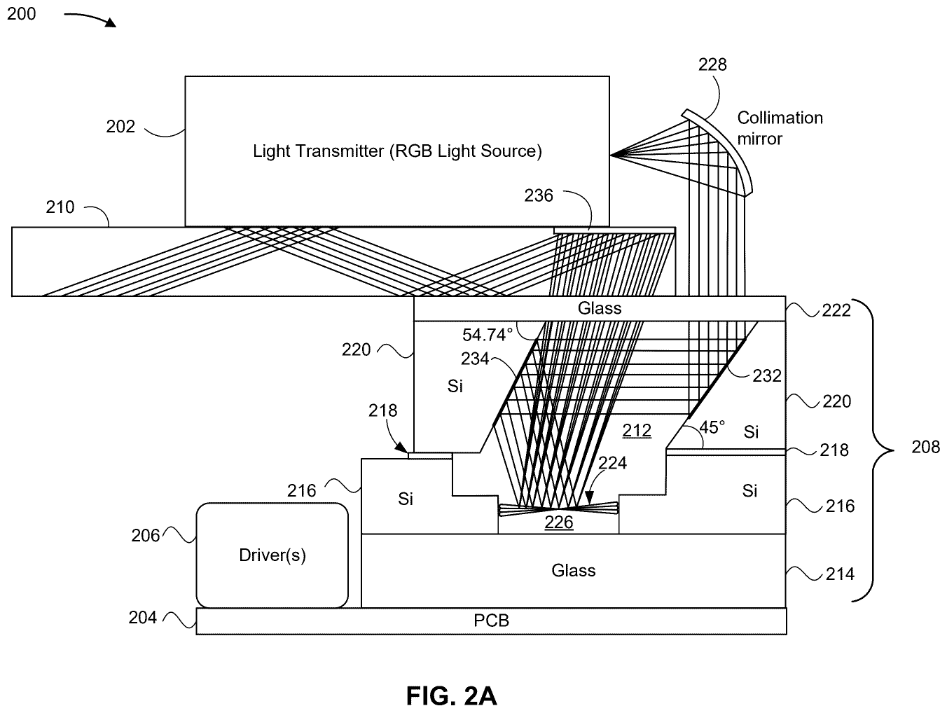

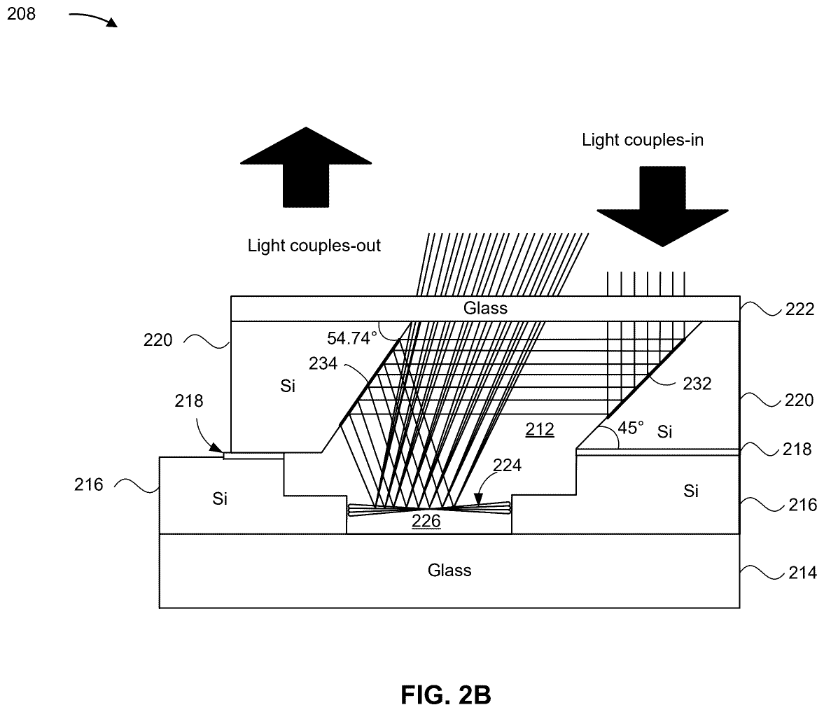

FIG. 2A is a cross-section of an image projection system 200 according to one or more implementations. The image projection system 200 may be implemented as a picture generation unit or light engine for eyeglasses. In other words, the image projection system 200 may be a wearable image projection system comprising an eyeglass lens. The image projection system 200 may include a light transmitter 202, a PCB 204, one or more drivers 206, a layer stack 208, and an output waveguide 210 arranged on the layer stack 208. In this example, the light transmitter 202 is arranged on the output waveguide 210 opposite to the layer stack 208.

The layer stack 208 may be arranged on the PCB 204 and may define an internal cavity 212. The layer stack 208 may include a first glass layer 214, a first semiconductor crystal layer 216 arranged on the first glass layer 214, a bonding interface 218, a second semiconductor crystal layer 220 arranged on the first semiconductor crystal layer 216 (e.g., on the bonding interface 218), and a second glass layer 222 arranged on the second semiconductor crystal layer 220. The output waveguide 210 is arranged on the second glass layer 222. The light transmitter 202 may be coupled to the output waveguide 110, opposite the second glass layer 222.

Internal surfaces of the first glass layer 214, the first semiconductor crystal layer 216, the second semiconductor crystal layer 220, and the second glass layer 222 may define the internal cavity 212. A MEMS mirror may be arranged in the internal cavity 212 and may be suspended from the first semiconductor crystal layer 216 over a back cavity 226 that is formed in the first semiconductor crystal layer 216.

The bonding interface 218 may bond the first semiconductor crystal layer 216 and the second semiconductor crystal layer 220. For example, the bond may be a glass frit bond, a fusion bond, or an anodic bond. Thus, in some implementations, the bonding interface 218 may be glass (e.g., for glass frit bonding or anodic bonding).

The image projection system 200 may further include couple-in optics 228 configured to couple the light beams into the internal cavity 112 through the second glass layer 222. For example, the couple-in optics 228 may be a concave mirror, such as a collimation mirror. The couple-in optics 228 may receive the light beams from the light transmitter 102 and couple the light beams into the internal cavity 112 through the second glass layer 222.

The second semiconductor crystal layer 220 includes a first internal slanted surface 232 and a second internal slanted surface 234 optically coupled to the first internal slanted surface 232. The first internal slanted surface 232 and the second internal slanted surface 234 define a portion of the internal cavity 212. The first internal slanted surface 232 may be configured to receive the light beams from the light transmitter 202 (e.g., from the couple-in optics 228) and direct the light beams toward the second internal slanted surface 234. The second internal slanted surface 234 may be configured to receive the light beams from the first internal slanted surface 232 and direct the light beams toward the MEMS mirror 224. The MEMS mirror 224 may steer the light beams to render the image. The MEMS mirror 224 may direct the light beams toward the output waveguide 210. Thus, the layer stack 208 may be configured such that the light beams are coupled into the internal cavity 212 through the second glass layer 222, and are coupled out of the internal cavity 212 through the second glass layer 222. The output waveguide 110 may receive the light beams from the MEMS mirror 224 and guide the light beams toward an eye of the user.

Similar to the first internal slanted surface 132 and the second internal slanted surface 134, the first internal slanted surface 232 and the second internal slanted surface 234 may be crystallographic surfaces. For example, the first internal slanted surface 232 may extend at a first angle of 45° or 54.74°, and the second internal slanted surface 134 may extend at a second angle of 45° or 54.74°.

The image projection system 200 may further include a waveguide grating 236 coupled to the output waveguide 210. The waveguide grating 236 may be arranged at an upper surface of the output waveguide 210 on a side opposite the second glass layer 222. The waveguide grating 236 may receive the light beams from the MEMS mirror 224 and couple the light beams into the output waveguide 210. Thus, the waveguide grating 236 may direct the light beams along a waveguide path of the output waveguide 210.

As indicated above, FIG. 2A is provided as an example. Other examples may differ from what is described with regard to FIG. 2A.

FIG. 2B is a cross-section of the layer stack 208 of the image projection system 200 described in connection with FIG. 2A. The layer stack 208 is configured such that the light beams are coupled into the internal cavity 112 through the second glass layer 222, and are coupled out of the internal cavity 112 through the second glass layer 222.

As indicated above, FIG. 2B is provided as an example. Other examples may differ from what is described with regard to FIG. 2B.

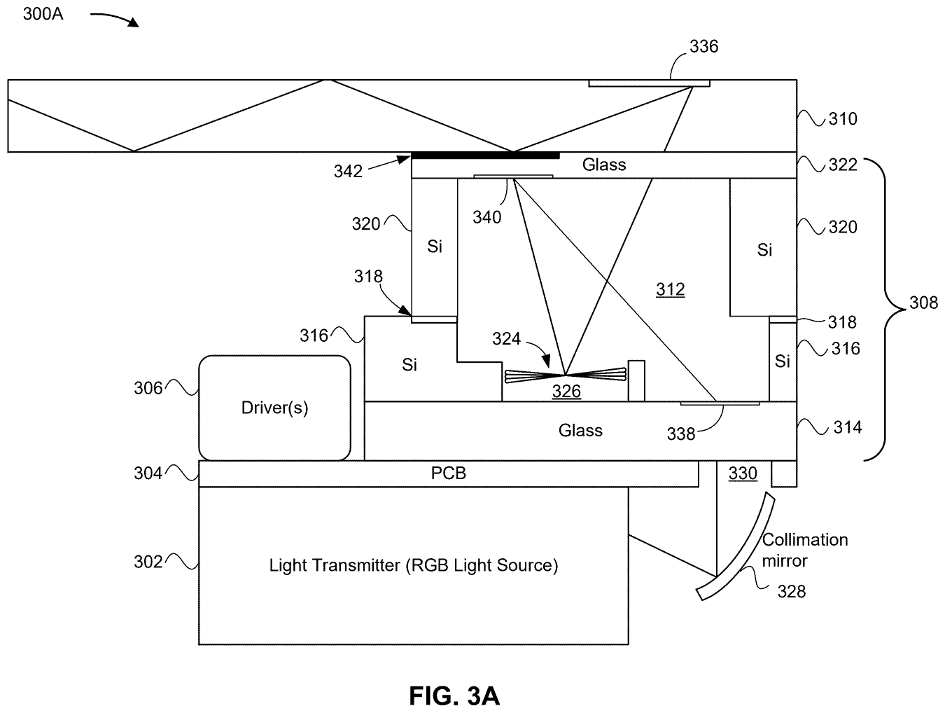

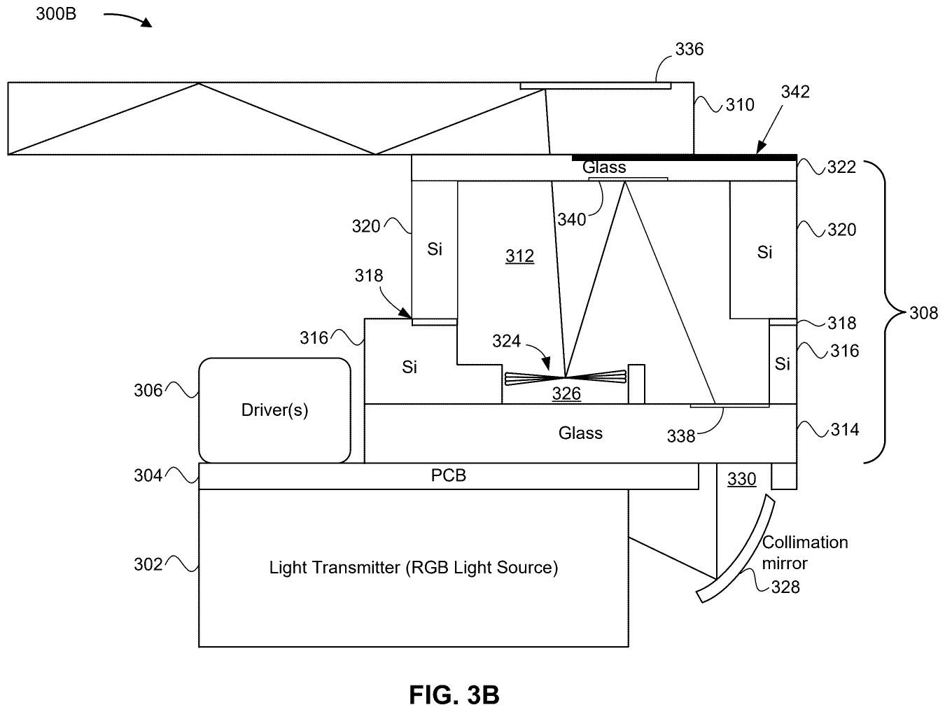

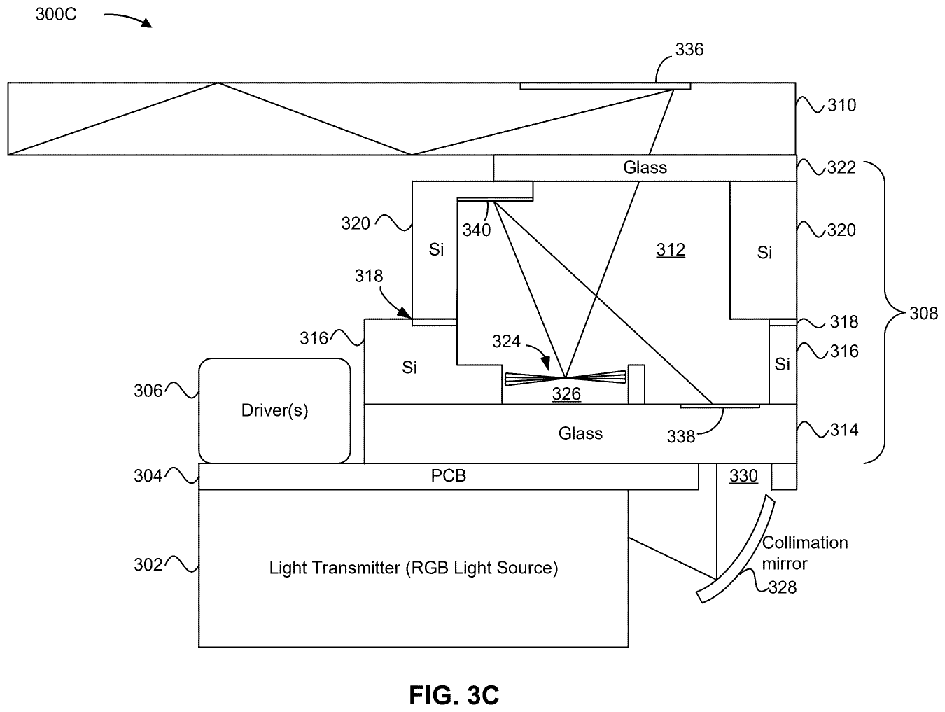

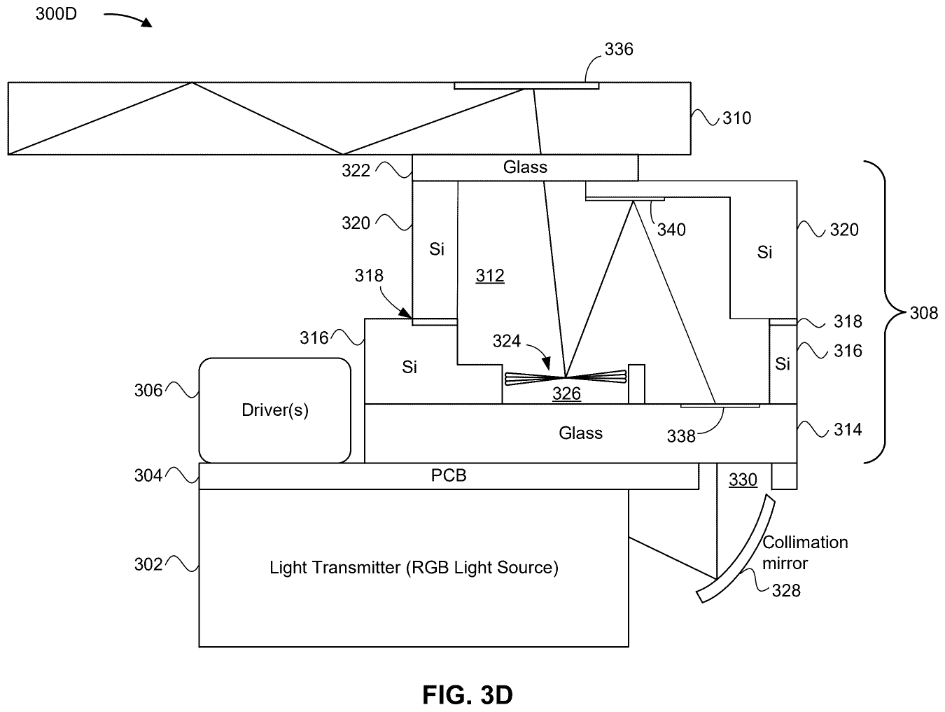

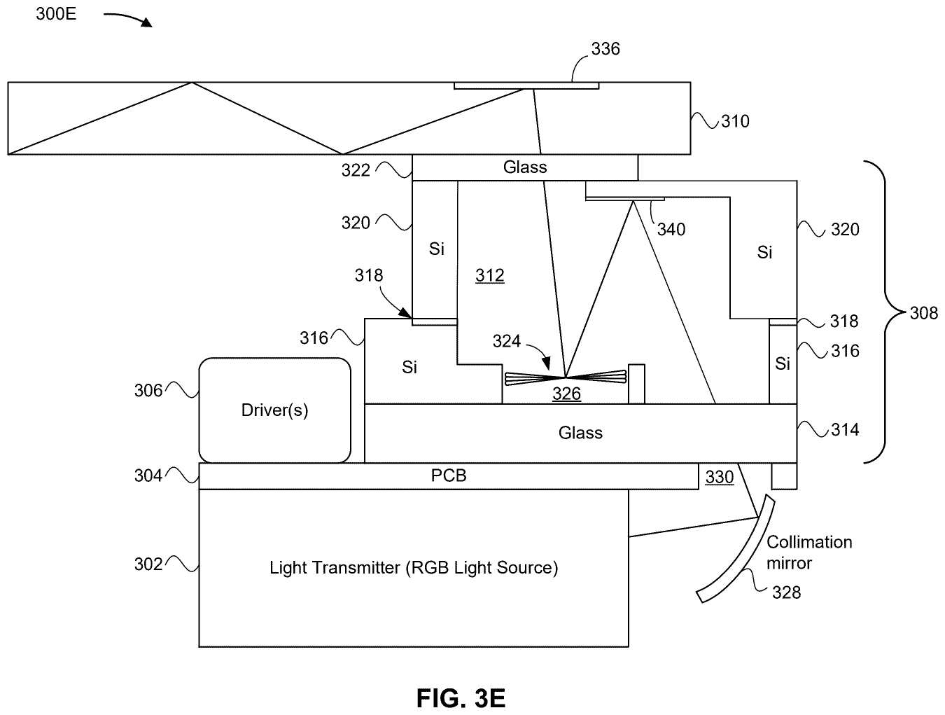

FIG. 3A is a cross-section of an image projection system 300A according to one or more implementations. The image projection system 300A may be similar to the image projection system 100 described in connection with FIGS. 1A and 1B, except that the image projection system 300A may not have internal slanted surfaces. Instead, deflecting elements, such as gratings, reflectors, or mirrors may be used within an internal cavity to direct light beams along an optical path.

The image projection system 300A may include a light transmitter 302, a PCB 304, one or more drivers 306, a layer stack 308 defining an internal cavity 312, and an output waveguide. The layer stack includes a first glass layer 314, a first semiconductor crystal layer 316 arranged on the first glass layer 314, a bonding interface 318, a second semiconductor crystal layer 320 arranged on the first semiconductor crystal layer 316 (e.g., on the bonding interface 218), and a second glass layer 322 arranged on the second semiconductor crystal layer 320. The internal surfaces of the first glass layer 314, the first semiconductor crystal layer 316, the second semiconductor crystal layer 320, and the second glass layer 322 may define the internal cavity 312. A MEMS mirror 324 may be arranged in the internal cavity 312 and suspended from the first semiconductor crystal layer 316 over a back cavity 326 that is formed in the first semiconductor crystal layer 316.

The output waveguide 310 may be arranged on the second glass layer 322. The output waveguide may receive the light beams from the MEMS mirror 324 and guide the light beams toward an eye of a user. A waveguide grating 336 may be coupled to the output waveguide 310, and may receive the light beams from the MEMS mirror 124 and couple the light beams into the output waveguide 310.

The light transmitter 302 may be coupled to the first glass layer 314, opposite the first semiconductor crystal layer 316. Couple-in optics 328 may couple the light beams from the light transmitter 302 into the internal cavity 312 through an opening 330 formed through the PCB 304. The light beams may pass through the opening 330 and through the first glass layer 314 to enter the internal cavity 312. Thus, the layer stack 308 may be configured such that the light beams are coupled into the internal cavity 312 through the first glass layer 314, and are coupled out of the internal cavity through the second glass layer 322.

The image projection system 300A may further include a first grating 338 arranged on the first glass layer 314, within the internal cavity 312 at an input side of the internal cavity 312. The first grating 338 may receive the light beams from the couple-in optics 328. The image projection system 300A may further include a deflecting element 340 arranged within the internal cavity 312 at an output side of the internal cavity 312. The deflecting element 340 may be arranged on an internal surface of the second glass layer 322 or on an internal surface of the second semiconductor crystal layer 320. In this example, the deflecting element 340 is arranged on an internal surface of the second glass layer 322. The deflecting element 340 may be a second grating or a reflective element. The deflecting element 340 may be optically coupled to the first grating 338. The first grating 338 may be configured to receive the light beams from the light transmitter 302 (e.g., from the couple-in optics 328) and direct the light beams toward the deflecting element 340. The deflecting element 340 may receive the light beams from the first grating 338 and direct the light beams toward the MEMS mirror 324. The MEMS mirror 324 may steer the light beams to render the image.

The image projection system 300A may further include a light blocking layer 342 arranged over the deflecting element 340 to prevent light leakage into the output waveguide 310. Thus, the light blocking layer 342 may be arranged between the deflecting element 340 and the output waveguide 310. In some implementations, the light blocking layer 342 may be arranged on the second glass layer 322 (e.g., between the second glass layer 322 and the output waveguide 310).

As indicated above, FIG. 3A is provided as an example. Other examples may differ from what is described with regard to FIG. 3A.

FIG. 3B is a cross-section of an image projection system 300B according to one or more implementations. The image projection system 300B may be similar to the image projection system 300A described in connection with FIG. 3A, except that positions of the deflecting element 340 and the light blocking layer 342 are shifted to the right. The first grating 338 may be configured to receive the light beams from the light transmitter 302 (e.g., from the couple-in optics 328) and direct the light beams toward the deflecting element 340. The deflecting element 340 may receive the light beams from the first grating 338 and direct the light beams toward the MEMS mirror 324. The MEMS mirror 324 may steer the light beams to render the image.

As indicated above, FIG. 3B is provided as an example. Other examples may differ from what is described with regard to FIG. 3B.

FIG. 3C is a cross-section of an image projection system 300C according to one or more implementations. The image projection system 300C may be similar to the image projection system 300A described in connection with FIG. 3A, with an exception that the deflecting element 340 is arranged on an internal surface of the second semiconductor crystal layer 320. The second semiconductor crystal layer 320 may have an overhang portion that extends over a portion of the MEMS mirror 324. The deflecting element 340 may be arranged on an internal surface of the overhang portion. A portion of the second glass layer 322 may be arranged on an external surface of the overhang portion.

As indicated above, FIG. 3C is provided as an example. Other examples may differ from what is described with regard to FIG. 3C.

FIG. 3D is a cross-section of an image projection system 300D according to one or more implementations. The image projection system 300D may be similar to the image projection system 300C described in connection with FIG. 3C, except that a position of the deflecting element 340 is shifted to the right. The second semiconductor crystal layer 320 may have an overhang portion that extends over a portion of the MEMS mirror 324. The deflecting element 340 may be arranged on an internal surface of the overhang portion. A portion of the second glass layer 322 may be arranged on an external surface of the overhang portion.

As indicated above, FIG. 3D is provided as an example. Other examples may differ from what is described with regard to FIG. 3D.

FIG. 3E is a cross-section of an image projection system 300E according to one or more implementations. The image projection system 300E may be similar to the image projection system 300D described in connection with FIG. 3D, except that the image projection system 300E does not include the first grating 338. As a result, the couple-in optics 328 may couple the light beams into the internal cavity 312 through the first glass layer 314, and the deflecting element may be optically coupled to the couple-in optics 328. Thus, the couple-in optics 328 may receive the light beams from the light transmitter 302 and direct the light beams toward the deflecting element 340. The deflecting element 340 may receive the light beams from the couple-in optics 328 and direct the light beams toward the MEMS mirror 324. The MEMS mirror 124 may steer the light beams to render an image. The output waveguide 310 is arranged on the second glass layer 322 for receiving the light beams from the MEMS mirror 324 and guiding the light beams toward an eye of a user.

The deflecting element 340 may be arranged on an internal surface of the second glass layer 322 or on an internal surface of the second semiconductor crystal layer 320.

The layer stack is configured such that the light beams are coupled into the internal cavity 312 through the first glass layer 314, and are coupled out of the internal cavity 312 through the second glass layer 322.

As indicated above, FIG. 3E is provided as an example. Other examples may differ from what is described with regard to FIG. 3E.

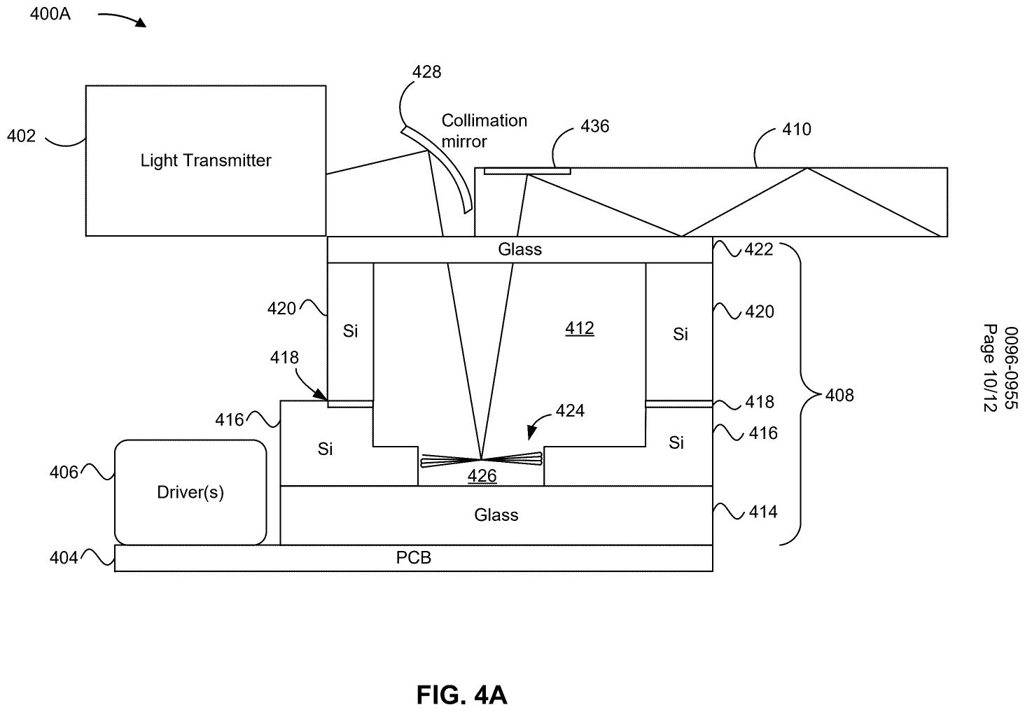

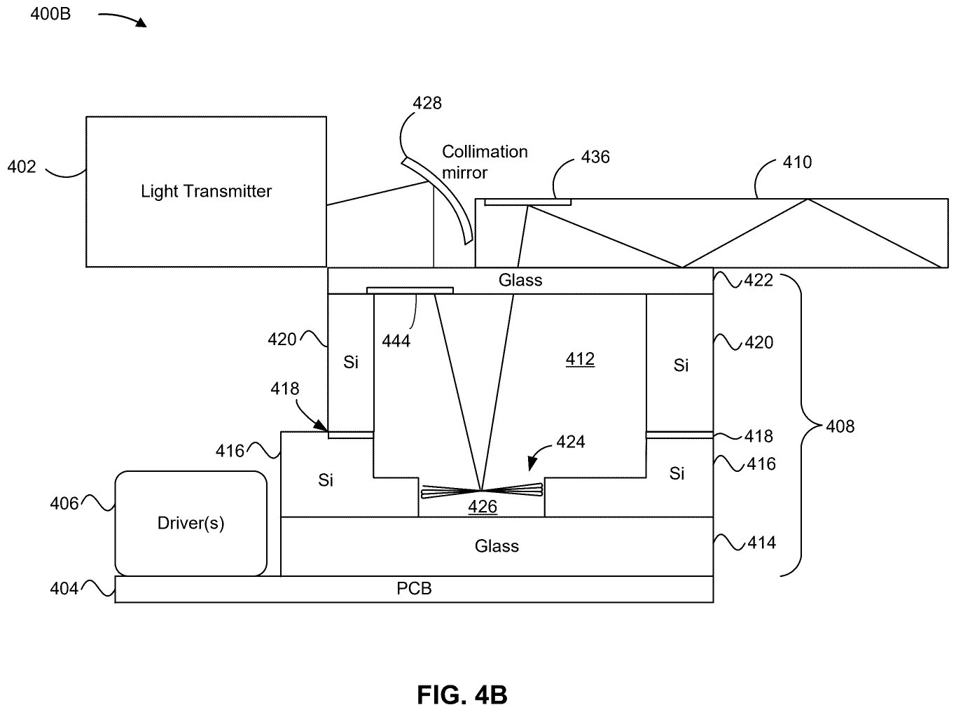

FIG. 4A is a cross-section of an image projection system 400A according to one or more implementations. The image projection system 400A may not have internal slanted surfaces. The image projection system 400A may include a light transmitter 402, a PCB 404, one or more drivers 406, a layer stack 408, and an output waveguide 410.

The layer stack 408 may be arranged on the PCB 404 and may define an internal cavity 412. Additionally, the layer stack 408 may include a first glass layer 414, a first semiconductor crystal layer 416 arranged on the first glass layer 414, a bonding interface 418, a second semiconductor crystal layer 420 arranged on the first semiconductor crystal layer 416 (e.g., on the bonding interface 418), and a second glass layer 422 arranged on the second semiconductor crystal layer 420. Internal surfaces of the first glass layer 414, the first semiconductor crystal layer 416, the second semiconductor crystal layer 420, and the second glass layer 422 may define the internal cavity 412. A MEMS mirror 424 may be arranged in the internal cavity 412 and suspended from the first semiconductor crystal layer 416 over a back cavity 426 that is formed in the first semiconductor crystal layer 416.

Couple-in optics 428 may be configured to receive light beams from the light transmitter 402 and couple the light beams into the internal cavity 412 through the second glass layer 422. The couple-in optics 428 may be optically coupled to the MEMS mirror 424. Thus, the MEMS mirror 424 may receive the light beams from the couple-in optics 428 and steer the light beams to render an image. The output waveguide 410, arranged on the second glass layer 422, may receive the light beams from the MEMS mirror 424 and guide the light beams toward an eye of a user. A waveguide grating 436 may be coupled to the output waveguide 410, and may receive the light beams from the MEMS mirror 424 and couple the light beams into the output waveguide 410. Thus, the layer stack 408 may be configured such that the light beams are coupled into the internal cavity 412 through the second glass layer 422, and are coupled out of the internal cavity 412 through the second glass layer 422.

As indicated above, FIG. 4A is provided as an example. Other examples may differ from what is described with regard to FIG. 4A.

FIG. 4B is a cross-section of an image projection system 400B according to one or more implementations. The image projection system 400B may be similar to the image projection system 400A described in connection with FIG. 4A, except that the image projection system 400B may include a grating 444 arranged on the second glass layer 422, within the internal cavity 412. For example, the grating 444 may be arranged on an internal surface of the second glass layer 422. The grating 444 may be optically coupled to the couple-in optics 428 and the MEMS mirror 424. Thus, the couple-in optics 428 may be configured to direct the light beams toward the grating 444, and the grating 444 may be configured to receive the light beams from the couple-in optics 428 and direct the light beams toward the MEMS mirror 424.

As indicated above, FIG. 4B is provided as an example. Other examples may differ from what is described with regard to FIG. 4B.

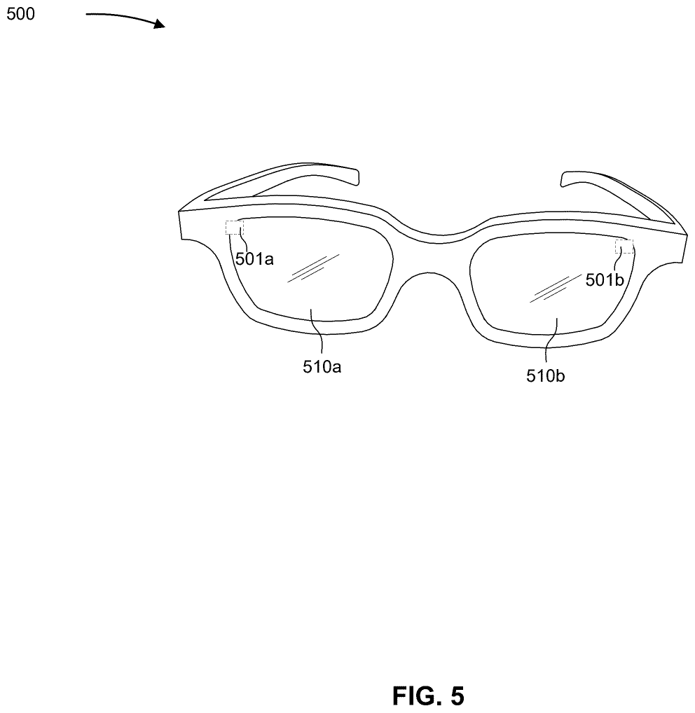

FIG. 5 is a diagram of extended reality eyeglasses 500 in accordance with one or more implementations. The extended reality eyeglasses 500 may include two image projection systems 501a and 501b coupled to respective eyeglass lenses 510a and 510b. The two image projection systems 501a and 501b may be any of the image projection systems described herein.

Thus, visible light projections, such as RGB projections, may be projected onto the eyes of a user according to respective preprogrammed scanning patterns, where RGB light pulses track the respective preprogrammed scanning patterns. The respective preprogrammed scanning patterns may be implemented by respective MEMS mirrors of the two image projection systems 501a and 501b. The two image projection systems 501a and 501b may be configured to project stereo images comprising a left-eye image and a right-eye image, respectively.

As indicated above, FIG. 5 is provided as an example. Other examples may differ from what is described with regard to FIG. 5.

### ASPECTS

The following provides an overview of some Aspects of the present disclosure:

Aspect 1: An image projection system, comprising: a light source configured to generate light beams corresponding to an image; a layer stack defining an internal cavity, the layer stack comprising: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer, the second semiconductor crystal layer, and the second glass layer define the internal cavity; and a microelectromechanical system (MEMS) mirror arranged in the internal cavity and suspended from the first semiconductor crystal layer, wherein the second semiconductor crystal layer includes a first internal slanted surface and a second internal slanted surface optically coupled to the first internal slanted surface, wherein the first internal slanted surface and the second internal slanted surface define a portion of the internal cavity, wherein the first internal slanted surface is configured to receive the light beams from the light source and direct the light beams toward the second internal slanted surface, wherein the second internal slanted surface is configured to receive the light beams from the first internal slanted surface and direct the light beams toward the MEMS mirror, and wherein the MEMS mirror is configured to steer the light beams to render the image.

Aspect 2: The image projection system of Aspect 1, further comprising: an output waveguide arranged on the second glass layer and configured to receive the light beams from the MEMS mirror and guide the light beams toward an eye of a user.

Aspect 3: The image projection system of Aspect 2, further comprising: a waveguide grating coupled to the output waveguide, wherein the waveguide grating is configured to receive the light beams from the MEMS mirror and couple the light beams into the output waveguide.

Aspect 4: The image projection system of Aspect 2, wherein the image projection system is a wearable image projection system comprising an eyeglass lens, and wherein the output waveguide is the eyeglass lens or is optically coupled to the eyeglass lens.

Aspect 5: The image projection system of any of Aspects 1-4, wherein the first internal slanted surface and the second internal slanted surface are crystallographic surfaces, wherein the first internal slanted surface extends at a first angle of 45° or 54.74°, and wherein the second internal slanted surface extends at a second angle of 45° or 54.74°.

Aspect 6: The image projection system of any of Aspects 1-5, wherein the first semiconductor crystal layer and the second semiconductor crystal layer are silicon crystal layers.

Aspect 7: The image projection system of any of Aspects 1-6, further comprising: couple-in optics configured to couple the light beams into the internal cavity through the first glass layer, wherein the light source is coupled to the first glass layer, opposite the first semiconductor crystal layer, and wherein the first internal slanted surface is configured to receive the light beams from the couple-in optics.

Aspect 8: The image projection system of Aspect 7, wherein the layer stack is configured such that the light beams are coupled into the internal cavity through the first glass layer, and are coupled out of the internal cavity through the second glass layer.

Aspect 9: The image projection system of any of Aspects 1-8, further comprising: couple-in optics configured to couple the light beams into the internal cavity through the second glass layer, and wherein the first internal slanted surface is configured to receive the light beams from the couple-in optics.

Aspect 10: The image projection system of Aspect 9, further comprising: an output waveguide arranged on the second glass layer and configured to receive the light beams from the MEMS mirror and guide the light beams toward an eye of a user, wherein the light source is coupled to the output waveguide, opposite the second glass layer.

Aspect 11: The image projection system of Aspect 9, wherein the layer stack is configured such that the light beams are coupled into the internal cavity through the second glass layer, and are coupled out of the internal cavity through the second glass layer.

Aspect 12: The image projection system of any of Aspects 1-11, wherein the first semiconductor crystal layer and the second semiconductor crystal layer are bonded by anodic bonding, glass frit bonding, or fusion bonding.

Aspect 13: An image projection system, comprising: a light source configured to generate light beams corresponding to an image; a layer stack defining an internal cavity, the layer stack comprising: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer, the second semiconductor crystal layer, and the second glass layer define the internal cavity; a microelectromechanical system (MEMS) mirror arranged in the internal cavity and suspended from the first semiconductor crystal layer; a first grating arranged on the first glass layer, within the internal cavity at an input side of the internal cavity; and a deflecting element arranged within the internal cavity at an output side of the internal cavity, wherein the deflecting element is optically coupled to the first grating, wherein the first grating is configured to receive the light beams from the light source and direct the light beams toward the deflecting element, wherein the deflecting element is configured to receive the light beams from the first grating and direct the light beams toward the MEMS mirror, and wherein the MEMS mirror is configured to steer the light beams to render the image.

Aspect 14: The image projection system of Aspect 13, further comprising: an output waveguide arranged on the second glass layer and configured to receive the light beams from the MEMS mirror and guide the light beams toward an eye of a user.

Aspect 15: The image projection system of Aspect 14, further comprising: a waveguide grating coupled to the output waveguide, wherein the waveguide grating is configured to receive the light beams from the MEMS mirror and couple the light beams into the output waveguide.

Aspect 16: The image projection system of Aspect 14, further comprising: a light blocking layer arranged over of the deflecting element to prevent light leakage into the output waveguide, wherein the light blocking layer is arranged between the deflecting element and the output waveguide.

Aspect 17: The image projection system of any of Aspects 13-16, wherein the deflecting element is a second grating or a reflective element.

Aspect 18: The image projection system of any of Aspects 13-17, wherein the deflecting element is arranged on an internal surface of the second glass layer or on an internal surface of the second semiconductor crystal layer.

Aspect 19: The image projection system of any of Aspects 13-18, further comprising: couple-in optics configured to couple the light beams into the internal cavity through the first glass layer, wherein the light source is coupled to the first glass layer, opposite the first semiconductor crystal layer, and wherein the first grating is configured to receive the light beams from the couple-in optics.

Aspect 20: The image projection system of Aspect 19, wherein the layer stack is configured such that the light beams are coupled into the internal cavity through the first glass layer, and are coupled out of the internal cavity through the second glass layer.

Aspect 21: An image projection system, comprising: a light source configured to generate light beams corresponding to an image; a layer stack defining an internal cavity, the layer stack comprising: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer arranged, the second semiconductor crystal layer, and the second glass layer define the internal cavity; a microelectromechanical system (MEMS) mirror arranged in the internal cavity and suspended from the first semiconductor crystal layer; couple-in optics configured to couple the light beams into the internal cavity through the first glass layer; and a deflecting element arranged within the internal cavity at an output side of the internal cavity, wherein the deflecting element is optically coupled to the couple-in optics, wherein the couple-in optics is configured to receive the light beams from the light source and direct the light beams toward the deflecting element, wherein the deflecting element is configured to receive the light beams from the couple-in optics and direct the light beams toward the MEMS mirror, and wherein the MEMS mirror is configured to steer the light beams to render the image.

Aspect 22: The image projection system of Aspect 21, further comprising: an output waveguide arranged on the second glass layer and configured to receive the light beams from the MEMS mirror and guide the light beams toward an eye of a user.

Aspect 23: The image projection system of Aspect 22, further comprising: a waveguide grating coupled to the output waveguide, wherein the waveguide grating is configured to receive the light beams from the MEMS mirror and couple the light beams into the output waveguide.

Aspect 24: The image projection system of any of Aspects 21-23, wherein the deflecting element is a grating or a reflective element.

Aspect 25: The image projection system of any of Aspects 21-24, wherein the deflecting element is arranged on an internal surface of the second glass layer or on an internal surface of the second semiconductor crystal layer.

Aspect 26: The image projection system of any of Aspects 21-25, wherein the layer stack is configured such that the light beams are coupled into the internal cavity through the first glass layer, and are coupled out of the internal cavity through the second glass layer.

Aspect 27: An image projection system, comprising: a light source configured to generate light beams corresponding to an image; a layer stack defining an internal cavity, the layer stack comprising: a first glass layer; a first semiconductor crystal layer arranged on the first glass layer; a second semiconductor crystal layer arranged on the first semiconductor crystal layer; and a second glass layer arranged on the second semiconductor crystal layer, wherein internal surfaces of the first glass layer, the first semiconductor crystal layer arranged, the second semiconductor crystal layer, and the second glass layer define the internal cavity; a microelectromechanical system (MEMS) mirror arranged in the internal cavity and suspended from the first semiconductor crystal layer; and couple-in optics configured to couple the light beams into the internal cavity through the second glass layer, wherein the couple-in optics is configured to receive the light beams from the light source and direct the light beams into the internal cavity, and wherein the MEMS mirror is configured to steer the light beams to render the image.

Aspect 28: The image projection system of Aspect 27, further comprising: an output waveguide arranged on the second glass layer and configured to receive the light beams from the MEMS mirror and guide the light beams toward an eye of a user.

Aspect 29: The image projection system of any of Aspects 27-28, wherein the layer stack is configured such that the light beams are coupled into the internal cavity through the second glass layer, and are coupled out of the internal cavity through the second glass layer.

Aspect 30: The image projection system of any of Aspects 27-29, further comprising: a grating arranged on the second glass layer, within the internal cavity, wherein the couple-in optics is configured to direct the light beams toward the grating, and wherein the grating is configured to receive the light beams from the couple-in optics and direct the light beams toward the MEMS mirror.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description, but is not intended to be exhaustive or to limit the implementations to the precise form disclosed. Modifications and variations are possible in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

Some implementations may be described herein in connection with thresholds. As used herein, “satisfying” a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the term “component” is intended to be broadly construed as hardware, firmware, or a combination of hardware and software. Systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein, refers to any of the foregoing structures or any other structure suitable for implementation of the techniques described herein. Software may be stored on a non-transitory computer-readable medium such that the non-transitory computer readable medium includes program code or a program algorithm stored thereon that, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal, further information. “Signal conditioning,” as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation, and any other processes required to make a signal suitable for processing after conditioning.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a and b, a and c, b and c, and a, b, and c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

1. An image projection system, comprising:
a light source configured to generate light beams corresponding to an image;
a layer stack defining an internal cavity, the layer stack comprising:
a first glass layer;
a first semiconductor crystal layer arranged on the first glass layer;
a second semiconductor crystal layer arranged on the first semiconductor crystal layer; and
a second glass layer arranged on the second semiconductor crystal layer,
wherein internal surfaces of the first glass layer, the first semiconductor crystal layer, the second semiconductor crystal layer, and the second glass layer define the internal cavity; and
a microelectromechanical system (MEMS) mirror arranged in the internal cavity and suspended from the first semiconductor crystal layer,
wherein the second semiconductor crystal layer includes a first internal slanted surface and a second internal slanted surface optically coupled to the first internal slanted surface,
wherein the first internal slanted surface and the second internal slanted surface define a portion of the internal cavity,
wherein the first internal slanted surface is configured to receive the light beams from the light source and direct the light beams toward the second internal slanted surface,
wherein the second internal slanted surface is configured to receive the light beams from the first internal slanted surface and direct the light beams toward the MEMS mirror, and
wherein the MEMS mirror is configured to steer the light beams to render the image.

2. The image projection system of claim 1, further comprising:
an output waveguide arranged on the second glass layer and configured to receive the light beams from the MEMS mirror and guide the light beams toward an eye of a user.

3. The image projection system of claim 2, further comprising:
a waveguide grating coupled to the output waveguide, wherein the waveguide grating is configured to receive the light beams from the MEMS mirror and couple the light beams into the output waveguide.

4. The image projection system of claim 2, wherein the image projection system is a wearable image projection system comprising an eyeglass lens, and
wherein the output waveguide is the eyeglass lens or is optically coupled to the eyeglass lens.

5. The image projection system of claim 1, wherein the first internal slanted surface and the second internal slanted surface are crystallographic surfaces,
wherein the first internal slanted surface extends at a first angle of 45° or 54.74°, and
wherein the second internal slanted surface extends at a second angle of 45° or 54.74°.

6. The image projection system of claim 1, wherein the first semiconductor crystal layer and the second semiconductor crystal layer are silicon crystal layers.

7. The image projection system of claim 1, further comprising:
couple-in optics configured to couple the light beams into the internal cavity through the first glass layer,
wherein the light source is coupled to the first glass layer, opposite the first semiconductor crystal layer, and
wherein the first internal slanted surface is configured to receive the light beams from the couple-in optics.

8. The image projection system of claim 7, wherein the layer stack is configured such that the light beams are coupled into the internal cavity through the first glass layer, and are coupled out of the internal cavity through the second glass layer.

9. The image projection system of claim 1, further comprising:
couple-in optics configured to couple the light beams into the internal cavity through the second glass layer, and
wherein the first internal slanted surface is configured to receive the light beams from the couple-in optics.

10. The image projection system of claim 9, further comprising:
an output waveguide arranged on the second glass layer and configured to receive the light beams from the MEMS mirror and guide the light beams toward an eye of a user,
wherein the light source is coupled to the output waveguide, opposite the second glass layer.

11. The image projection system of claim 9, wherein the layer stack is configured such that the light beams are coupled into the internal cavity through the second glass layer, and are coupled out of the internal cavity through the second glass layer.

12. The image projection system of claim 1, wherein the first semiconductor crystal layer and the second semiconductor crystal layer are bonded by anodic bonding, glass frit bonding, or fusion bonding.

13. An image projection system, comprising:
a light source configured to generate light beams corresponding to an image;
a layer stack defining an internal cavity, the layer stack comprising:
a first glass layer;
a first semiconductor crystal layer arranged on the first glass layer;
a second semiconductor crystal layer arranged on the first semiconductor crystal layer; and
a second glass layer arranged on the second semiconductor crystal layer,
wherein internal surfaces of the first glass layer, the first semiconductor crystal layer, the second semiconductor crystal layer, and the second glass layer define the internal cavity;
a microelectromechanical system (MEMS) mirror arranged in the internal cavity and suspended from the first semiconductor crystal layer;
a first grating arranged on the first glass layer, within the internal cavity at an input side of the internal cavity; and
a deflecting element arranged within the internal cavity at an output side of the internal cavity, wherein the deflecting element is optically coupled to the first grating,
wherein the first grating is configured to receive the light beams from the light source and direct the light beams toward the deflecting element,
wherein the deflecting element is configured to receive the light beams from the first grating and direct the light beams toward the MEMS mirror, and
wherein the MEMS mirror is configured to steer the light beams to render the image.

14. The image projection system of claim 13, further comprising:
an output waveguide arranged on the second glass layer and configured to receive the light beams from the MEMS mirror and guide the light beams toward an eye of a user.

15. The image projection system of claim 14, further comprising:
a waveguide grating coupled to the output waveguide, wherein the waveguide grating is configured to receive the light beams from the MEMS mirror and couple the light beams into the output waveguide.

16. The image projection system of claim 14, further comprising:
a light blocking layer arranged over of the deflecting element to prevent light leakage into the output waveguide, wherein the light blocking layer is arranged between the deflecting element and the output waveguide.

17. The image projection system of claim 13, wherein the deflecting element is a second grating or a reflective element.

18. The image projection system of claim 13, wherein the deflecting element is arranged on an internal surface of the second glass layer or on an internal surface of the second semiconductor crystal layer.

19. The image projection system of claim 13, further comprising:
couple-in optics configured to couple the light beams into the internal cavity through the first glass layer,
wherein the light source is coupled to the first glass layer, opposite the first semiconductor crystal layer, and
wherein the first grating is configured to receive the light beams from the couple-in optics.

20. The image projection system of claim 19, wherein the layer stack is configured such that the light beams are coupled into the internal cavity through the first glass layer, and are coupled out of the internal cavity through the second glass layer.

21. An image projection system, comprising:
a light source configured to generate light beams corresponding to an image;
a layer stack defining an internal cavity, the layer stack comprising:
a first glass layer;
a first semiconductor crystal layer arranged on the first glass layer;
a second semiconductor crystal layer arranged on the first semiconductor crystal layer; and
a second glass layer arranged on the second semiconductor crystal layer,
wherein internal surfaces of the first glass layer, the first semiconductor crystal layer arranged, the second semiconductor crystal layer, and the second glass layer define the internal cavity;
a microelectromechanical system (MEMS) mirror arranged in the internal cavity and suspended from the first semiconductor crystal layer;
couple-in optics configured to couple the light beams into the internal cavity through the first glass layer; and
a deflecting element arranged within the internal cavity at an output side of the internal cavity, wherein the deflecting element is optically coupled to the couple-in optics,
wherein the couple-in optics is configured to receive the light beams from the light source and direct the light beams toward the deflecting element,
wherein the deflecting element is configured to receive the light beams from the couple-in optics and direct the light beams toward the MEMS mirror, and
wherein the MEMS mirror is configured to steer the light beams to render the image.

22. The image projection system of claim 21, further comprising:
an output waveguide arranged on the second glass layer and configured to receive the light beams from the MEMS mirror and guide the light beams toward an eye of a user.

23. The image projection system of claim 22, further comprising:
a waveguide grating coupled to the output waveguide, wherein the waveguide grating is configured to receive the light beams from the MEMS mirror and couple the light beams into the output waveguide.

24. The image projection system of claim 21, wherein the deflecting element is a grating or a reflective element.

25. The image projection system of claim 21, wherein the deflecting element is arranged on an internal surface of the second glass layer or on an internal surface of the second semiconductor crystal layer.

26. The image projection system of claim 21, wherein the layer stack is configured such that the light beams are coupled into the internal cavity through the first glass layer, and are coupled out of the internal cavity through the second glass layer.

27. An image projection system, comprising:
a light source configured to generate light beams corresponding to an image;
a layer stack defining an internal cavity, the layer stack comprising:
a first glass layer;
a first semiconductor crystal layer arranged on the first glass layer;
a second semiconductor crystal layer arranged on the first semiconductor crystal layer; and
a second glass layer arranged on the second semiconductor crystal layer,
wherein internal surfaces of the first glass layer, the first semiconductor crystal layer arranged, the second semiconductor crystal layer, and the second glass layer define the internal cavity;
a microelectromechanical system (MEMS) mirror arranged in the internal cavity and suspended from the first semiconductor crystal layer; and
couple-in optics configured to couple the light beams into the internal cavity through the second glass layer,
wherein the couple-in optics is configured to receive the light beams from the light source and direct the light beams into the internal cavity, and
wherein the MEMS mirror is configured to steer the light beams to render the image.

28. The image projection system of claim 27, further comprising:
an output waveguide arranged on the second glass layer and configured to receive the light beams from the MEMS mirror and guide the light beams toward an eye of a user.

29. The image projection system of claim 27, wherein the layer stack is configured such that the light beams are coupled into the internal cavity through the second glass layer, and are coupled out of the internal cavity through the second glass layer.

30. The image projection system of claim 27, further comprising:
a grating arranged on the second glass layer, within the internal cavity,
wherein the couple-in optics is configured to direct the light beams toward the grating, and
wherein the grating is configured to receive the light beams from the couple-in optics and direct the light beams toward the MEMS mirror.
